(19) United States
(12) Patent Application Publication
(10) Pub. No.: US 2010/0054852 A1
(43) Pub. Date: Mar. 4, 2010

(54) Chimney Flue Cleaning Tool Having a High-Torque Quick-Connect Coupling Device

(75) Inventor: Steven N. Snyder, Montgomery Village, MD (US)

Correspondence Address: DOWNS RACHLIN MARTIN PLLC, 199 MAIN STREET, P O BOX 190, BURLINGTON, VT, 05402-0190, US

(73) Assignee: RUTLAND FIRE CLAY COMPANY, Rutland, VT (US)

(21) Appl. No.: 12/550,247

(22) Filed: Aug. 28, 2009

Related U.S. Application Data
(60) Provisional application No. 61/093,025, filed on Aug. 29, 2008.

(51) Int. Cl. B25G 3/04; F16B 21/00

(52) U.S. Cl. 403/301; 403/322.1

(57) ABSTRACT

A chimney flue cleaning tool having a plurality of pole segments, a cleaning device, and a quick-connect pushbutton coupling device designed to transmit large amounts of torque via interengaging torque-transmitting structures on both of the male and female parts of the coupling that work to transmit the torque between the two parts while freeing the pushbutton from having to resist any substantial amount of torque. In one embodiment, the chimney flue cleaning tool has a coupling device with a groove and a tongue for transmitting a significant amount of torque along the longitudinal axis of the tool.

### RELATED APPLICATION DATA

This application claims the benefit of priority of U.S. Provisional Patent Application Ser. No. 61/093,025, filed on Aug. 29, 2008, and titled “High-Torque Quick-Connect Coupling Device,” which is incorporated by reference herein in its entirety.

### FIELD OF THE INVENTION

The present disclosure generally relates to the field of chimney maintenance tools. In particular, the present disclosure is directed to chimney flue cleaning tool having a high-torque quick-connect coupling device.

### BACKGROUND

There are a variety of situations where a mechanical coupling must handle a relatively large amount of torque but the components joined by the coupling are desired to be readily disconnected from one another. One such situation occurs in the chimney sweeping industry, wherein long multi-segment poles are used to support a chimney sweeping brush during chimney sweeping. As can be readily envisioned, relatively large torques are frequently applied to these poles during chimney sweeping. Multiple pole segments are often necessary because of long brush-support lengths needed for chimney sweeping and the superior torsional rigidity provided by tubular poles. Of course, each of the multiple pole segments must necessarily have some sort of coupling device that couples adjacent segments together. Such coupling devices include threaded coupling devices and button-type coupling devices.

In general, threaded coupling devices are limited in the direction of the torque that can be applied, since excessive torque applied in the wrong direction will act to loosen the connection. The original type of spring-loaded button-type coupling devices used in the chimney sweeping industry have a cylindrical button (a/k/a “snap button”) springingly engaged with a male part of the device. When the male part is coupled to a corresponding female part of the device along the torsional axis of the device, the cylindrical button extends in a radial direction relative to the torsional axis through a circular aperture in the female part. This type of coupling transmits torque around the torsional axis between the male and female parts and longitudinal forces along the torsional axis between the male and female parts by shear force generally transverse to the longitudinal central axis of the button. A problem with this cylindrical button arrangement is that the strength of the coupling device in torsion is severely constrained by the limited size of the button.

A spring-loaded button-type coupling device capable of handling larger torques is disclosed in U.S. Pat. No. 6,688,800 to Kresge (the '800 patent herein), which is incorporated herein by reference in its entirety for its teachings relative to conventional coupling devices. As seen in the '800 patent, the increased torque strength is primarily due to elongating the spring-loaded button in a direction parallel to the rotational (torsional) axis of the coupling device. This design has several shortcomings. For example, the oblong button is not a standard part and is more difficult to manufacture and assemble than a round button. Second, there is still a limited amount of surface area being utilized because the button cannot extend the entire length of the connector. Third, the connector is relatively difficult to engage since the button and the slot must be visually aligned in order to engage correctly. Fourth, due to the large size of the button it is more prone to becoming inadvertently disengaged through contact with a protrusion or other object.

### SUMMARY

In one implementation, the present disclosure is directed to a chimney flue cleaning tool. The chimney flue cleaning tool includes: a coupling device having a longitudinal central axis and including a male part including a button springingly engaged with the male part so as to be movable in a direction substantially radial to the longitudinal central axis of the coupling device; a female part for matingly receiving at least a portion of the male part in a direction along the longitudinal central axis of the coupling device, the female part including an aperture for engaging the button when the male part and the female part are coupled together; a pair of conformally interengaging torque-transmitting structures being part of corresponding respective ones of the male part and the female part, the pair of conformally interengaging torque-transmitting structures for inhibiting rotation of the male part and the female part relative to one another about the longitudinal central axis; a pole segment coupled to the coupling device; and a cleaning device coupled to the coupling device opposite the pole segment.

In another implementation, the present disclosure is directed to a system for connecting a pair of elongate structures having a longitudinal central axis. The system includes: a first tubular structure having an end coupled with a male coupling, the male coupling having a generally annular external surface, an internal surface, a cavity extending radially from the external surface to the internal surface, and a button having a top, wherein the cavity is sized and dimensioned to accommodate the button, and wherein the button is sized and dimensioned to move radially between a depressed position and an engaged position so that when the button is in the depressed position the top does not extend to about the external surface and when the button is in the engaged position the top extends beyond the external surface; a second tubular structure having an end coupled with a female coupling, the female coupling having a generally annular outside surface, an inside surface having a diameter larger than the external surface, and an aperture extending radially from the external surface to the internal surface, wherein the aperture is sized and dimensioned to accommodate the button; and means for transmitting torque about the longitudinal central axis between the male coupling and the female coupling, the means not including the button.

### BRIEF DESCRIPTION OF THE DRAWINGS

For the purpose of illustrating the invention, the drawings show aspects of one or more embodiments of the invention. However, it should be understood that the present disclosure is not limited to the precise arrangements and instrumentalities shown in the drawings, wherein:

FIG. 1 is a longitudinal cross-sectional view of the female part of a high-torque quick-connect coupling device according to an embodiment of the present disclosure;

FIG. 2 is an isometric view of the female part of FIG. 1;

FIG. 3 is a longitudinal cross-sectional view of the male part, without a pushbutton assembly, of the high-torque quick-connect coupling device that corresponds to the female part of FIGS. 1 and 2;

FIG. 4 is an isometric view of a male part of FIG. 3, also without a pushbutton assembly;

FIG. 5 is an enlarged cross-sectional partial view of the male part of FIGS. 3 and 4 showing a pushbutton assembly engaged with the male part;

FIG. 6 is a side view of a high-torque quick-connect coupling device according to another embodiment of the present disclosure, showing the female part interengaged with the male part;

FIG. 7 is a side view of a high-torque quick-connect coupling device according to yet another embodiment of the present disclosure, showing the female part interengaged with the male part; and

FIG. 8 is a side view of a chimney sweeping tool that includes a multi-segment pole having a plurality of high-torque quick-connect coupling devices of the present disclosure.

### DETAILED DESCRIPTION

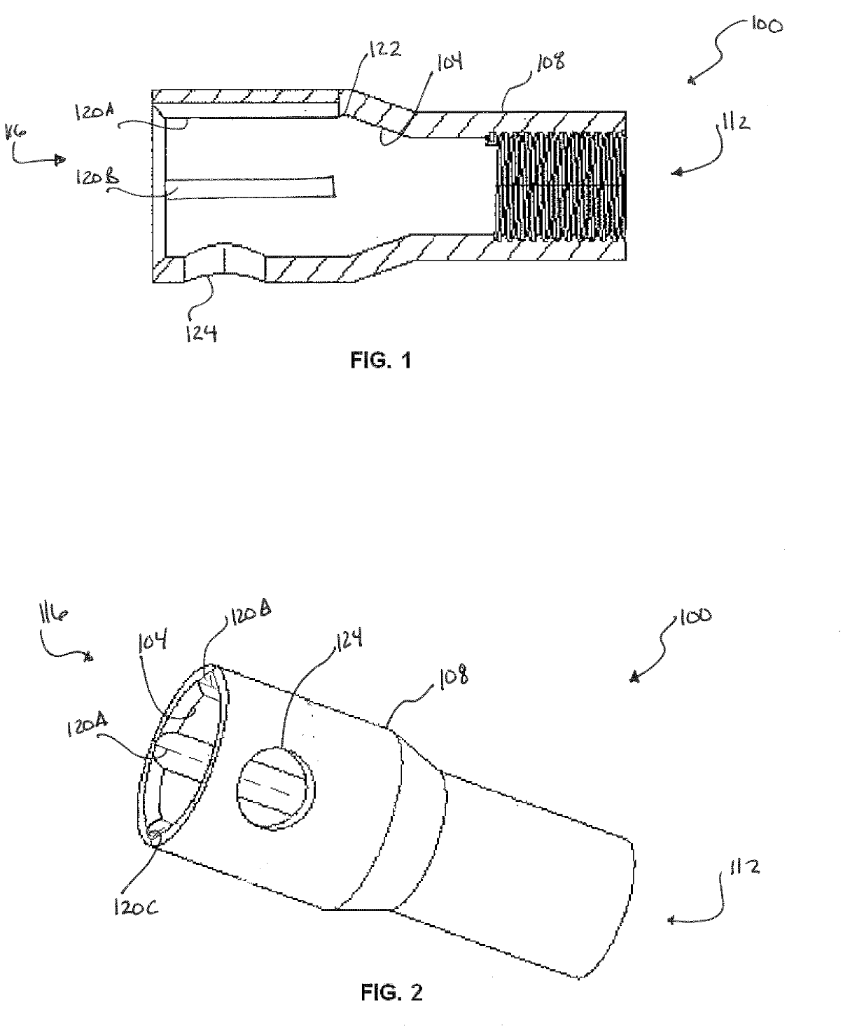

Referring first to FIG. 8, there is shown a chimney flue cleaning tool 800 that includes a cleaning device, for example, brush 804, and a multi-segment pole 808 comprising a plurality of segments 808A-D connected together by a plurality of unique coupling devices 812A-C. As those skilled in the art will readily appreciate, chimney flue cleaning tool 800 can be used to clean chimney flues (not shown) of various cross-sectional shapes and sizes by selecting brush 804 to be of a shape and size appropriate for the cross-sectional shape and size of the flue being cleaned. It is noted that while chimney flue cleaning tool 800 is shown as having a four-segment pole 808, more or fewer than four segments 808A-D can be provide to adapt the cleaning tool to a flue of any length. As described below in detail, each coupling device 812A-C includes one or more features that provide enhanced performance relative to conventional coupling devices. Examples of these features include high-torque transmittance and a design that inhibits inadvertent release of coupled segments 808A-D from one another. Details of several embodiments of high-torque quick-connect coupling are described in connection with FIGS. 1-7.

In one aspect, then, the present disclosure is directed to a quick-connect coupling device that can be designed to transmit large amounts of torque, especially relative to conventional pushbutton type quick-connect coupling devices that essentially transmit all of the torque through variously shaped pushbuttons. A quick-connect coupling of the present disclosure retains the pushbutton release of conventional similar coupling devices because of their ease of use. However, a quick-connect coupling of the present disclosure includes interengaging torque-transmitting structures on both of the male and female parts of the coupling that work to transmit the torque between the two parts while freeing the pushbutton from having to resist any substantial amount of torque. The following FIGS. 1-7 illustrate several exemplary embodiments of such a high-torque quick-connect coupling device. It is noted that while the illustrated example of FIG. 8 shows high-torque quick-connection coupling devices 812A-C being used in the context of a chimney flue cleaning tool 800, those skilled in the art will instantly recognize other situations in which a high-torque quick-connect coupling device of the present disclosure can be used, including those situations where such a coupling device replaces a conventional pushbutton coupling device.

FIGS. 1-5 illustrate various components of a first example of a high-torque quick-connect coupling device made in accordance with concepts of the present disclosure. FIGS. 1 and 2 show an example female part 100 of the device as having an inside surface 104 and an outside surface 108. While FIGS. 1 and 2 show female part 100 having a generally circular cross-section, the female part can take on many other shapes such as squares (e.g., coupling devices 812A-C), hexagons, ovals, pentagons, etc. In addition, female part 100 may have an outside surface 108 that has a different shape than inside surface 104, for example, the outside surface may have a square cross-section while the inside surface has a circular cross-section.

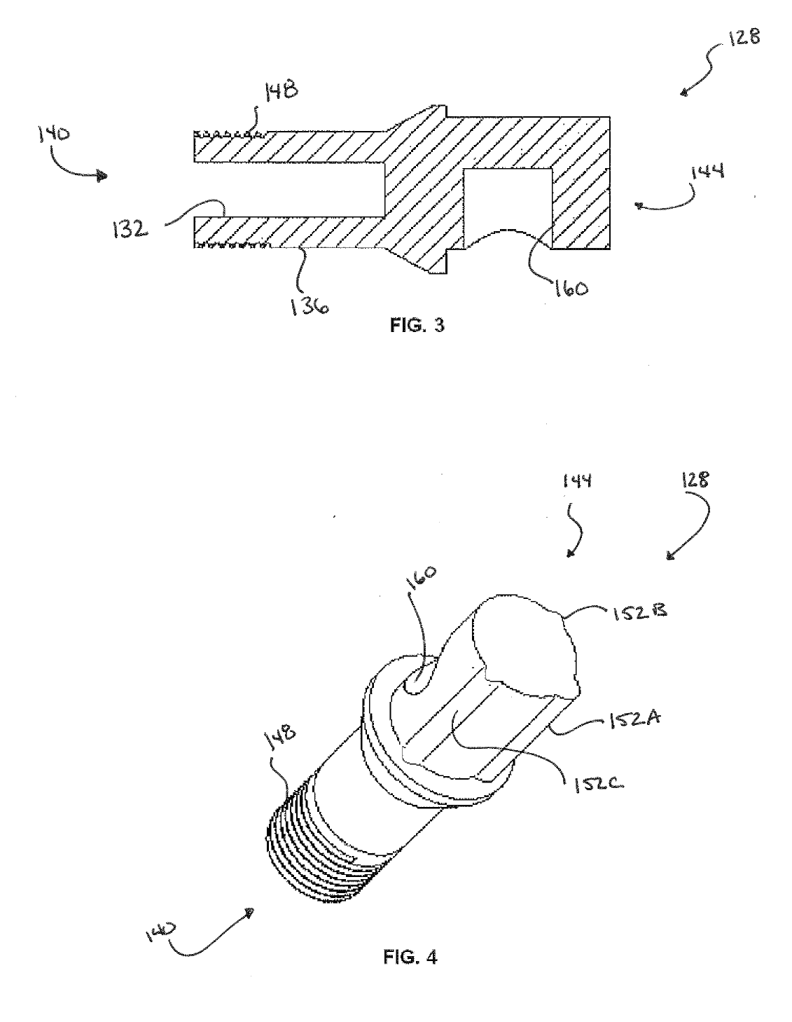

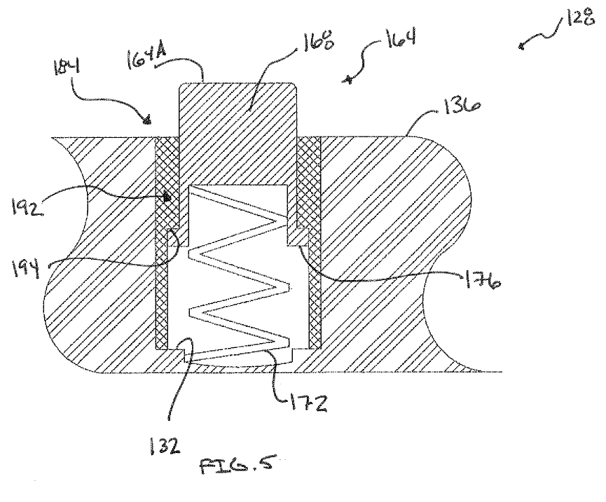

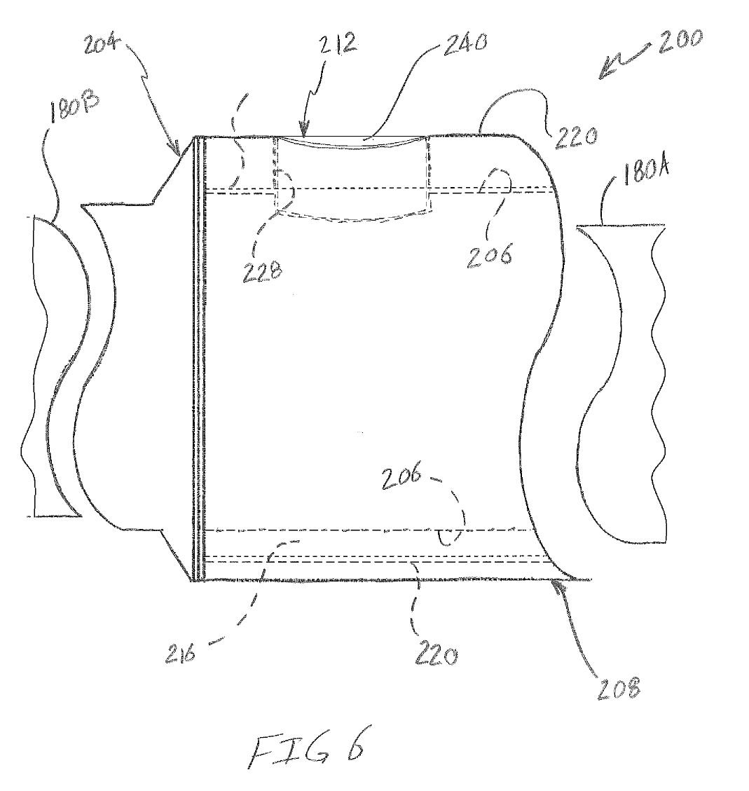

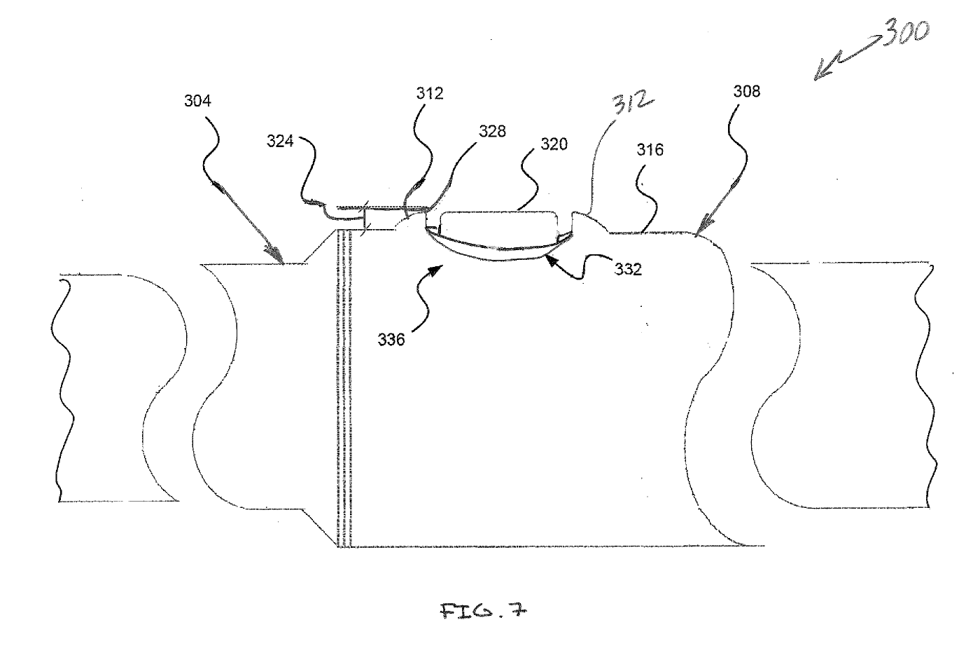

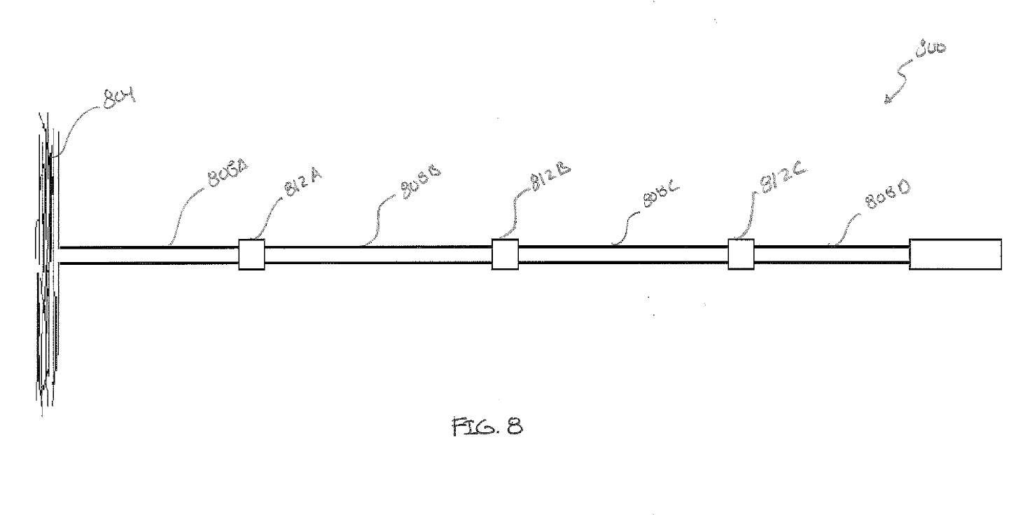

Female part 100 is generally hollow, with a connecting end 112 and a receiving end 116. Connecting end 112 may have threads 114 or other means for joining female part 100 to another item 180A (as shown in FIG. 6), such as a pole, pole segment (e.g., one of segments 808A-D of FIG. 8), rod, etc., with a suitable configuration for attachment (an example is shown in FIGS. 6 and 7). In this example, female part 100 also includes grooves or channels 120A-C extending from proximate connecting end 112 to a terminus point 122 within the female part (shown in FIG. 1). The function of groove 120 will become clear after reading the below description of a corresponding male part 128 (as shown in FIGS. 3 and 4) of the high-torque quick-connect coupling device. Female part 100 also includes an aperture 124 that extends from the inside surface 104 to the outside surface 108. As will be explained further below, aperture 124 is configured to accommodate a pushbutton assembly 164 (shown in FIG. 5) on male part 128 that holds the two parts together longitudinally.

FIGS. 3-5 show an example male part 128 having an inside surface 132 and an outside surface 136. While FIGS. 3 and 5 show male part 128 having a generally circular cross-section, the male part can take on many other shapes that correspond to the shape of female part 100, such as squares, hexagons, ovals, pentagons, etc. In addition, male part 128 may have an outside surface 136 that has a different shape than inside surface 132, for example, the outside surface may have a square cross-section while the inside surface has a circular cross-section.

Male part 128 is at least partially hollow, with a connecting end 140 and a female part receiving end 144. Connecting end 140 can have receiving threads 148 or other means for joining male part 128 to a corresponding item 180B (shown in FIGS. 6 and 7), such as a pole, pole segment (e.g., one of segments 808A-D of FIG. 8), rod, etc., with a suitable configuration for attachment. In this example, male part 128 includes tongues or keys 152A-C extending from proximate connecting end 144 to a terminus 156 within the male part (best seen in FIG. 4). Male part 128 also includes a cavity 160 that, as shown in FIG. 5, receives a pushbutton assembly 164. As seen in FIG. 5, pushbutton assembly 164 includes a button 168 and a biasing member 172 (described more fully below).

As can best be seen from FIGS. 2 and 4, the torque-transmitting structures used in this example are grooves 120A-C formed in the female part 100 of FIG. 2 and corresponding tongues 152A-C formed on the male part 128 of FIG. 4. Grooves 120 and tongues 152 in this example extend the entire length of the mating portions of male part 128 and female part 100. Of course, tongues 152 and grooves 120 are sized so as to minimize rotational play between the two parts so as not to impart stress into pushbutton assembly 164 due to any relative rotation therebetween. This length of the torque transmitting structures is an important feature of this embodiment, as it allows the entire mating, or overlap, length of the two parts to be active in torque transmission. This is juxtaposed to conventional button-type quick-connect coupling devices wherein even the longest of buttons in a direction along the torsional axis of the coupling device, such as the elongated button configuration of U.S. Pat. No. 6,688,800, has to be shorter than the overlap length of the two parts for the simple reason that the button must be spaced from the ends of the mating portions to enable the proper functionality. In other embodiments, the lengths of grooves 120 and tongues 152 may be shorter than overlap length. In yet other embodiments, grooves 120 may be located on male part 128 and tongues 152 located on female part 100. In still further embodiments, the torque-transmitting structures can also be integral to the design of receiving end 116 and receiving end 144. For instance, if receiving end 116 has a generally square cross-section and receiving end 144 has a conformally mating shape, the torque transmitting structures would, in this instance, be the inside corners of receiving end 116 and the outside corners of receiving end 144.

As shown in FIGS. 1 and 3, male part 128 and female part 100 includes threaded ends 148, 114, respectively, for threadingly engaging corresponding pole segments 180A-B, respectively, of FIGS. 6 and 7 (or other item, such as cleaning device 804) desired to be coupled together by the high-torque quick-coupling device. In other embodiments, each male part 128 and female part 100 may be joined to the item at issue by another means, such as one or more rivets, screws, bolts, or other mechanical fasteners or may be joined by another method, such as welding, brazing, crimping, swaging, etc. Those skilled in the art will appreciate the variety of ways that male part 128 and female part 100 may be secured to an item. As those skilled in the art will also readily appreciate, one, the other or both of female and male parts 100, 128 can also be formed integrally with the corresponding respective item.

FIG. 5 shows an example of a particular button 168 that may be used with pushbutton assembly 164 in male part 128 of FIGS. 3 and 4. In this example, biasing member 172 is a coil spring that causes button 168 to rebound as the user releases the button. In the example shown, pushbutton assembly 164 has an arrangement wherein button 168 is located in a button-retaining insert 184 that is press-fit into corresponding cavity 160 (shown in FIGS. 3 and 4) in male part 128. In assembled male part 128, button-retaining insert 184 is located within cavity 160 and provides two primary functions. The first of these functions is to provide a button guide 192 for ensuring the proper orientation of button 168 during actuation. The second of these functions is to provide a shoulder 194 that limits the travel of button 168 after a user releases the button. When button 168 is in its undepressed state (shown), biasing member 172 within male part 128 biases an outwardly-turned flange 176 on the button against shoulder 194. Friction between button-retaining insert 184 and the wall of cavity 160 is greater than the bias force applied by biasing member 172 against the button-retaining insert so that the button-retaining insert does not disengage the cavity. Depressing of button 168 by a user causes biasing member 172 to compress, thereby allowing the button to move downward (relative to FIG. 5) and the upper surface 168A of the button to move into button-retaining insert 184.

FIG. 6 shows another example of high-torque quick-connect coupling device 200 of the present disclosure. As seen in FIG. 6, coupling device 200 has a male coupling 204 that has been inserted into a corresponding female coupling 208. In this example, male coupling 204 has a predominately cylindrical exterior surface 206 (except for tongue 216 (see below)) and includes a pushbutton assembly 212 that may be the same as or similar to pushbutton assembly 164 of FIG. 5 described above with respect to the high-torque quick-connect coupling device of FIGS. 1-5. In the example of FIG. 6, tongue 216 of male coupling 204 is interengaged with a corresponding groove 220 disposed on female coupling 208 in the manner of tongues 152 and grooves 120 of male and female parts 128, 100 of FIGS. 4 and 2, respectively. In this example, male coupling 204 and female coupling 208 are connected to corresponding respective items 180B, 180A.

In this example, female coupling 208 has an external surface 220 that is generally cylindrical. As shown in FIG. 6, the top of button 240 is flush with, and contoured to follow the curvature of, external surface 220. As those skilled in the art can readily appreciate, this configuration minimizes exposed edges that would tend to catch on excess mortar and other projections inside a chimney flue during cleaning operations. This configuration also tends to inhibit inadvertent depressing of button 240 by projections within a chimney flue during cleaning operations. Alternatively, female coupling 208 may also include plural depressions (not shown) surrounding aperture 228 that form a channel of sorts (not shown) from which button 240 is accessed by the user.

FIG. 7 shows coupling device 300, having a male coupling 304 and a female coupling 308. In this example, female coupling 308 has at least one shoulder 312 protruding above an external surface 316. Generally, shoulder 312 provides protection for inadvertent pushing of a button 320. Shoulder 312 has a height 324, as defined by the difference between the exterior surface and a point 328 on shoulder 312 that is furthest from the longitudinal center of the female coupling 308. Generally, point 328 is about coextensive with the top of button 320; however, in alternative embodiments, point 328 may be higher or lower than the top of button 320. Coupling device 300 may also include plural depressions 332. Generally, depressions 332 and shoulders 312 to create a channel 336 from which the user accesses button 320.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A chimney flue cleaning tool, comprising:
a coupling device having a longitudinal central axis and including:
a male part including a button springingly engaged with said male part so as to be movable in a direction substantially radial to the longitudinal central axis of the coupling device;
a female part for matingly receiving at least a portion of the male part in a direction along the longitudinal central axis of the coupling device, said female part including an aperture for engaging said button when said male part and said female part are coupled together;
a pair of conformally interengaging torque-transmitting structures being part of corresponding respective ones of said male part and said female part, said pair of conformally interengaging torque-transmitting structures for inhibiting rotation of said male part and said female part relative to one another about the longitudinal central axis;
a pole segment coupled to said coupling device; and
a cleaning device coupled to said coupling device opposite said pole segment.

2. The chimney flue cleaning tool of claim 1, wherein said pair of conformally interengaging torque-transmitting structures each have a length corresponding to said portion of the male part received by the female part.

3. The chimney flue cleaning tool of claim 1, wherein one of said pair of conformally interengaging torque-transmitting structures is a groove and the other is a tongue.

4. The chimney flue cleaning tool of claim 3, wherein said groove extends longitudinally from an edge of said corresponding male part or female part to a first terminus, and said tongue extends longitudinally from proximate an edge of said corresponding male part or female part to a second terminus.

5. The chimney flue cleaning tool of claim 1, wherein said coupleable device includes plural pairs of conformally interengaging torque-transmitting structures.

6. The chimney flue cleaning tool of claim 5, wherein a first set of said plural pairs includes grooves and/or tongues, and wherein a second set of said plural pairs includes grooves and/or tongues corresponding to said first set.

7. The chimney flue cleaning tool of claim 1, wherein said button has a top and wherein said aperture is formed between plural opposing ridges that are transverse to the longitudinal axis of said female part, said plural opposing ridges being sized and dimensioned to have an outside edge that extends about the same radial distance from the longitudinal axis of the coupleable device as said top when said male part is coupled with said female part.

8. The chimney flue cleaning tool of claim 1, wherein said button has a top and wherein said female part has a shoulder portion, said shoulder portion increasing the distance from the longitudinal axis of said female part so that said shoulder portion has an outside edge about coterminous with said top when said male part is coupled with said female part.

9. The chimney flue cleaning tool of claim 1, wherein said cleaning device is a chimney brush.

10. A system for connecting a pair of elongate structures having a longitudinal central axis, the system comprising:
a first tubular structure having an end coupled with a male coupling, said male coupling having a generally annular external surface, an internal surface, a cavity extending radially from said external surface to said internal surface, and a button having a top, wherein said cavity is sized and dimensioned to accommodate said button, and wherein said button is sized and dimensioned to move radially between a depressed position and an engaged position so that when said button is in said depressed position said top does not extend to about said external surface and when said button is in said engaged position said top extends beyond said external surface;
a second tubular structure having an end coupled with a female coupling, said female coupling having a generally annular outside surface, an inside surface having a diameter larger than said external surface, and an aperture extending radially from said external surface to said internal surface, wherein said aperture is sized and dimensioned to accommodate said button; and
means for transmitting torque about the longitudinal central axis between said male coupling and said female coupling, said means not including said button.

11. The system of claim 10, wherein said means is a pair of structures inhibiting rotation of said first tubular structure and said second tubular structure relative to one another about the longitudinal central axis when said male coupling is interengaged with said female coupling.

12. The system of claim 11, wherein said pair of structures includes a groove and a tongue, wherein said groove extends longitudinally from an edge of said corresponding male coupling or female coupling to a first terminus, and said tongue extends longitudinally from proximate an edge of said corresponding male coupling or female coupling to a second terminus.

13. The system of claim 10, wherein said means is plural pairs of structures inhibiting rotation of said first tubular structure and said second tubular structure relative to one another about the longitudinal central axis when said male coupling is interengaged with said female coupling.

14. The system of claim 13, wherein a first set of said plural pairs includes grooves and/or tongues, and wherein a second set of said plural pairs includes grooves and/or tongues that are conformally interengageable with said first set.

15. The system of claim 10, wherein said aperture is partially formed between plural opposing ridges that are transverse to the longitudinal axis of said female coupling, said plural opposing ridges having outside edges that are coextensive with said outside surface.

16. The system of claim 15, wherein said female coupling has a thickness and includes plural depressions having a variable depth, said depressions and said ridges encircling said aperture.

17. The system of claim 10, wherein said female coupling has a shoulder portion, said shoulder portion increasing the distance from the longitudinal axis beyond said external surface so that said shoulder portion has an outside edge about coterminous with said top when said male part is coupled with said female part.
